(19) United States
(12) Patent Application Publication
(10) Pub. No.: US 2016/0311675 A1
(43) Pub. Date: Oct. 27, 2016

(54) METHOD AND APPARATUS FOR FILLING A FUEL TANK

(71) Applicant: FERRELLGAS, L.P., Winston-Salem, NC (US)

(72) Inventors: Tod Daniel Brown, Winston-Salem, NC (US); Morgan William Dull, Winston-Salem, NC (US); Mark Andrew Romanik, Winston-Salem, NC (US)

(21) Appl. No.: 15/102,837

(22) PCT Filed: Dec. 9, 2014
(86) PCT No.: PCT/US14/69382

§ 371 Date: Jun. 8, 2016

Related U.S. Application Data
(60) Provisional application No. 61/913,778, filed on Dec. 9, 2013.
(60) Provisional application No. 61/916,623, filed on Dec. 16, 2013.

(51) Int. Cl. B67D 7/34; F17C 13/02; F17C 5/00; B67D 7/22; B67D 7/04

(52) U.S. Cl. CPC B67D 7/348; B67D 7/22; B67D 7/04; F17C 5/00; F17C 13/028; F17C 2205/058; F17C 2221/033; F17C 2221/035; F17C 2223/0153; F17C 2250/032; F17C 2250/034; F17C 2270/0745

(57) ABSTRACT

The present invention is directed to a method for filling a fuel tank, the method comprising receiving a fuel tank, receiving data associated with the fuel tank from at least one sensor, processing the data, wherein processing the data comprises determining an amount of fuel required to fill the fuel tank to a predetermined level; and dispensing the determined amount of fuel from a storage tank into the fuel tank.

### BACKGROUND

Metal fuel tanks, such as liquid propane tanks, are commonly used to fuel grills and cooking burners, as well as powering generators, outdoor heaters, insect traps and other appliances. These tanks may be exchanged, purchased, refilled, or returned at various participating merchants' locations. Typically, hardware stores, grocery stores, convenience stores, gas stations, or the like make individual fuel tanks available for exchange, purchase, refill, or return. Individual fuel tanks may be stored in a secure storage area (e.g., a locked corral or another enclosure) inside or adjacent to the merchant's establishment. Conventionally, when the fuel in such tanks is depleted, the user must either locate an establishment that has the facilities and personnel to refill the tank or, alternatively, locate an establishment that provides tank exchange services in which the user returns the empty tank and purchases a new or refurbished full tank.

For establishments that refill a fuel tank, such establishments mush invest in and maintain the facilities to refill tanks and must also train their personnel in the proper procedures for safely refilling the tank, including determining whether the tank meets the necessary requirements for refilling. For these reasons, there remains a need for a system and method for providing a user with a full tank that is safe and that eliminates the cost and effort associated with training personnel to refill tanks

### BRIEF SUMMARY

Embodiments of the invention comprise a kiosk for convenient refilling, exchanging, and/or dispensing of fuel tanks, such as liquid propane tanks In one embodiment, a method is provided for filling a fuel tank based on data received from at least one sensor. The method comprises the steps of receiving a fuel tank; receiving data associated with the fuel tank from at least one sensor; processing the data, wherein processing the data comprises determining an amount of fuel required to fill the fuel tank to a predetermined level; and dispensing the determined amount of fuel from a storage tank into the fuel tank.

In some embodiments, the method comprises receiving the fuel tank at least partially in an aperture of a housing, wherein the aperture is configured to receive the fuel tank;

In some embodiments, the method comprises providing an interface that enables a user to select a service comprising at least one of exchanging, purchasing, refilling, and/or returning a fuel tank.

In some embodiments, the data from the at least one sensor represents information comprising at least one of the weight of the fuel tank, the fuel type associated with the fuel tank, the amount of remaining fuel in the fuel tank, the type of valve in the fuel tank, and the location of the valve in the fuel tank.

In some embodiments, the at least one sensor comprises a scale, a thermometer, a fuel gauge, a fuel probe, a camera, a motion detector, and/or a metal detector.

In some embodiments, the processing step comprises determining a monetary value associated with the determined amount of fuel.

In some embodiments, the method further comprises prompting the user for payment of the determined monetary value.

In some embodiments, the dispensing step comprises dispensing the fuel to the fuel tank through a hose.

In some embodiments, a first end of the hose is operatively coupled to the storage tank while a second end of the hose is operatively coupled to the fuel tank.

In some embodiments, the data represents information comprising the amount of fuel in the storage tank and the method further comprises transmitting the data to a remote terminal, analyzing the data, via the remote terminal, to determine whether the amount of fuel in the storage tank has decreased below a predetermined level, and when the amount of fuel in the storage tank has decreased below a predetermined level, filling the storage tank with fuel.

In another embodiment, an apparatus, such as a kiosk, is provided for refilling a fuel tank with fuel. The apparatus comprises a storage tank configured to store fuel; a controller; at least one sensor, the at least one sensor being configured to assess data associated with the fuel tank, and wherein the at least one sensor is operatively connected to the controller and configured to transmit the data associated with the fuel tank to the controller; a fuel distribution mechanism, the fuel distribution mechanism being operatively connected to the storage tank and controller and being configured to operatively connect to fuel tank, and wherein the controller processes the data to determine an amount of fuel required to fill the fuel tank to a predetermined level and wherein the controller activates the fuel distribution mechanism and the fuel distribution mechanism transfers fuel from the storage tank to the fuel tank until the fuel is filled to the predetermined level.

In some embodiments, the controller comprises a memory; and a processor.

In some embodiments, the apparatus comprises a display in operable communication with the controller and wherein the controller further comprises a module stored in the memory, executable by the processor, and configured to present an interface on the display enabling a user to select a service associated with at least one of exchanging, purchasing, refilling, or returning the fuel tank.

In some embodiments, the controller further comprises a module stored in the memory, executable by the processor, and configured to receive the data associated with the fuel tank; process the data associated with the fuel tank; and activate the fuel distribution mechanism to initiate the dispensing of the determined amount of fuel from the storage tank into the fuel tank.

In some embodiments, the apparatus comprises a remote terminal and the controller further comprises a module stored in the memory, executable by the processor, and configured to receive data from the at least one sensor representing information comprising the amount of fuel remaining in the storage tank; process the data; and transmit data to the remote terminal.

In some embodiments, the apparatus comprises a housing defining at least one aperture configured to at least partially receive the fuel tank.

In some embodiments, the house comprises an access door used to access the at least one aperture.

In some embodiments, the housing comprises a plurality of storage compartments for storing empty fuel tanks.

In some embodiments, the apparatus further comprises at least one of a touchscreen display or a keyboard in operable communication with the controller.

### BRIEF DESCRIPTION OF THE DRAWINGS

Having thus described embodiments of the invention in general terms, reference will now be made to the accompanying drawings, where:

FIG. 1 illustrates an exemplary process flow for a method of filling a fuel tank based on received sensory information, in accordance with one embodiment of the invention;

FIG. 2 illustrates a front view of an apparatus for filling a fuel tank, in accordance with one embodiment of the invention;

FIG. 3 illustrates a front view of an apparatus for filling a fuel tank with a storage tank and a storage corral adjacent to the apparatus, in accordance with one embodiment of the invention;

FIG. 4 illustrates a top view of an apparatus for filling a fuel tank, in accordance with one embodiment of the invention;

FIG. 5 illustrates a top view of an apparatus for filling a fuel tank with a storage tank and a storage corral adjacent to the apparatus, in accordance with one embodiment of the invention;

FIG. 6 illustrates an exemplary user interface that enables a user to select a service associated with processing a fuel tank, in accordance with embodiments of the present invention; and

FIG. 7 illustrates an exemplary system diagram of an apparatus, in accordance with one embodiment of the invention;

### DETAILED DESCRIPTION

Embodiments of the present invention now may be described more fully hereinafter with reference to the accompanying drawings in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

In some embodiments, an “entity” as used herein may be a gas company. For the purposes of this invention, a “gas company” may be defined as any organization, entity, merchant, or the like in the business of manufacturing, refining, refilling, exchanging, transporting, or distributing fuel, either in bulk or in individual tanks “Fuel” may refer to solid, liquid, or gas fuel and may include but is not limited to liquid propane, kerosene, natural gas, gasoline, or the like.

A user may be enabled to interact with the present invention. In some embodiments, the “user” may be a customer who wishes to refill an empty fuel tank with fuel or exchange an empty fuel tank for a full fuel tank. In other embodiments, the user may be a prospective customer who wishes to purchase a tank of fuel. Alternatively, the user may be associated with the entity, a gas company, or a third party vendor (e.g., a business owner, a merchant, a repairman, a maintenance specialist, an equipment operator, an attendant, an inspector, or the like).

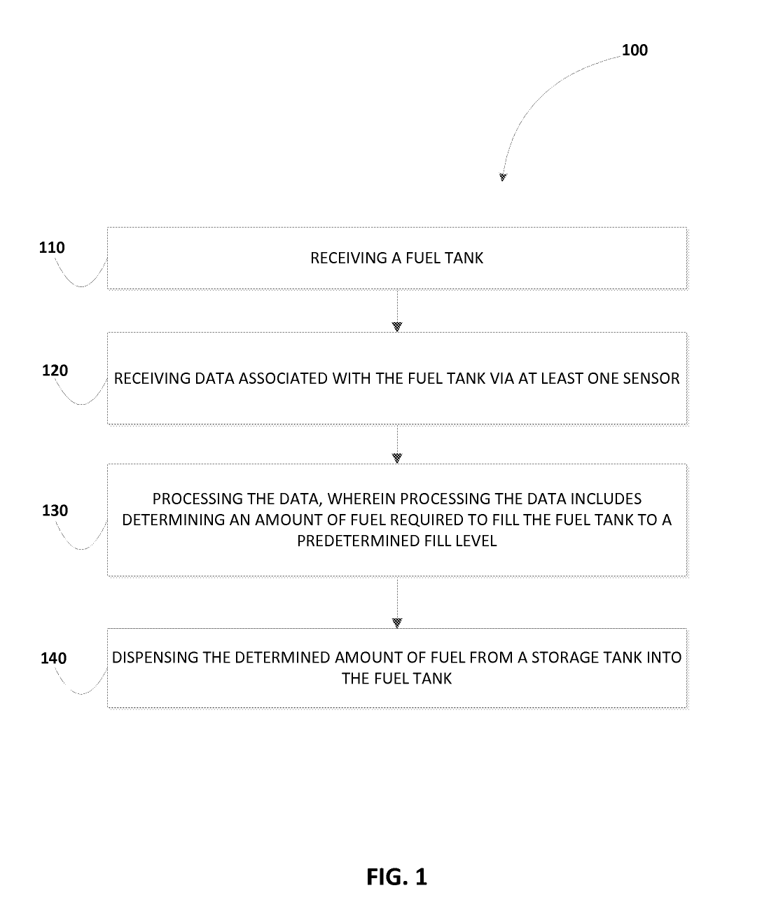

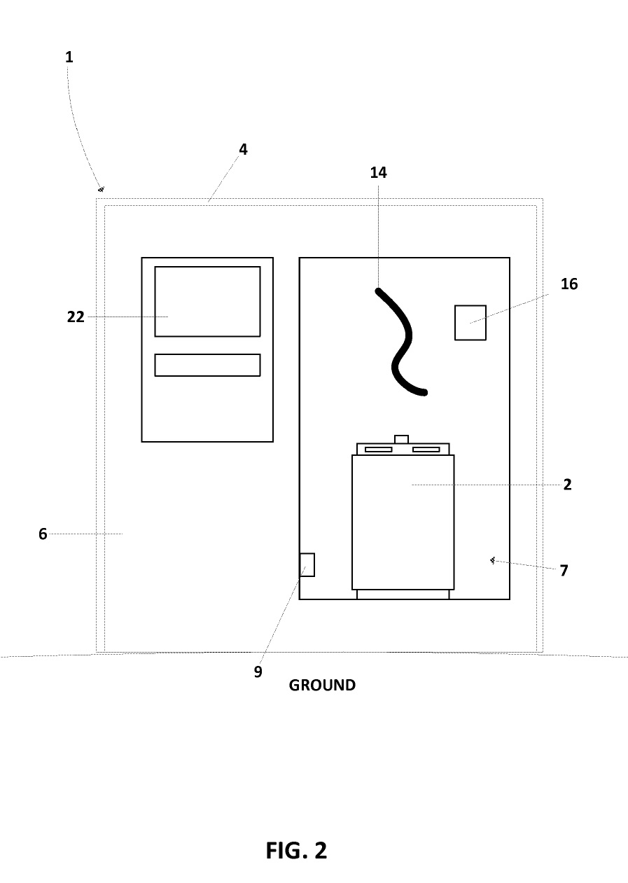

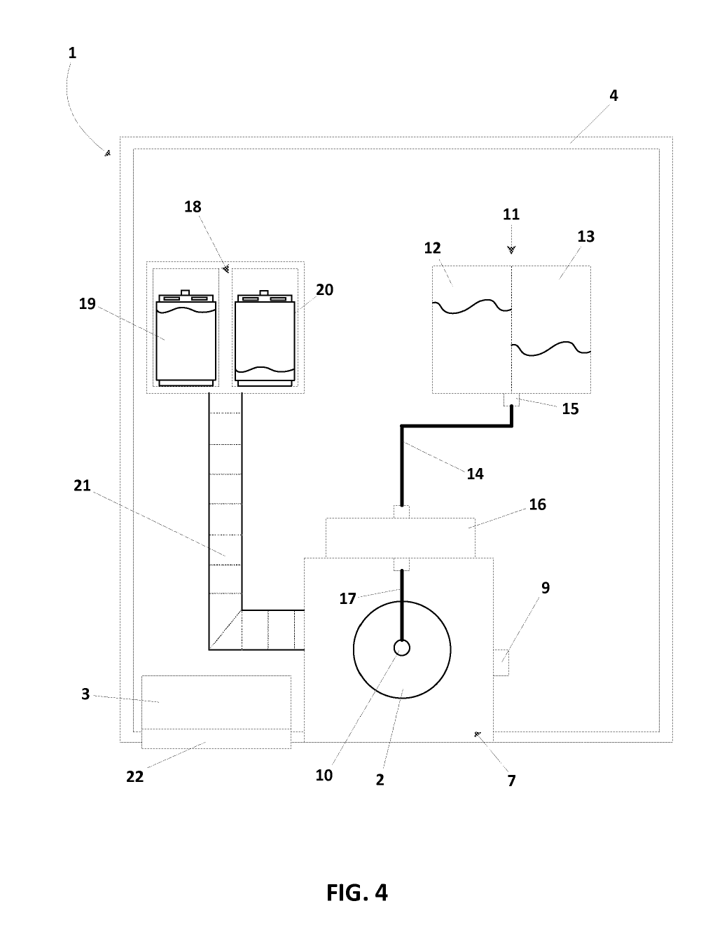

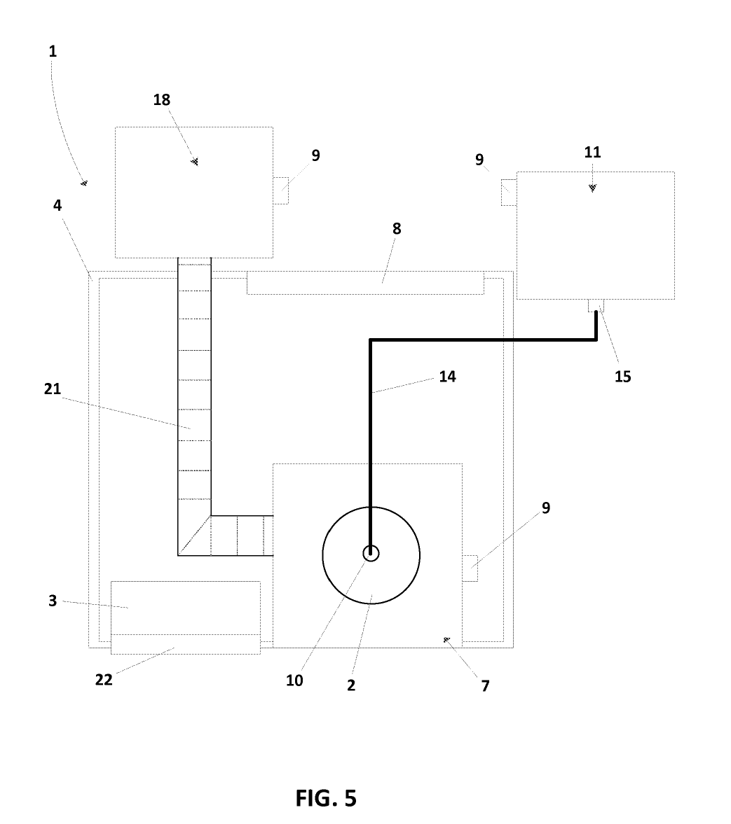

The present invention addresses the problems associated with existing refilling of fuel tanks Referring to FIGS. 1-7 and, in particular, FIGS. 2-5, there is illustrated an apparatus 1 for filling a fuel tank 2. The apparatus 1 may comprise an interactive kiosk that enables a user to exchange, purchase, refill, or return a fuel tank 2. The apparatus may include a housing 4. The housing 4 may comprise a substantially rigid frame and outer enclosure for enclosing some or all of the other components of the apparatus 1. The configuration of the housing 4 can vary. For purposes of example and not limitation, the housing 4 can have a substantially rectangular configuration (as shown in FIGS. 4 and 5), square configuration, or cylindrical configuration. The bottom side of the housing 1 is preferably substantially planar. In some embodiments, the bottom of the housing 4 may include one or more adjustable feet 5 that not only ensure the apparatus 1 is level, but also provide stability. The housing 4 may include locks, pins, posts, bolts, rods, screws, or the like for securely coupling the apparatus 1 to the ground, a vertical wall, or another structure. In some embodiments, the height of the top surface of the housing 4 may be adjustable along the sides 6. The outer enclosure of the housing 4 may comprise in whole or in part a substantially rigid material (e.g., plastic, fiberglass, steel, composite, an alloy, or the like).

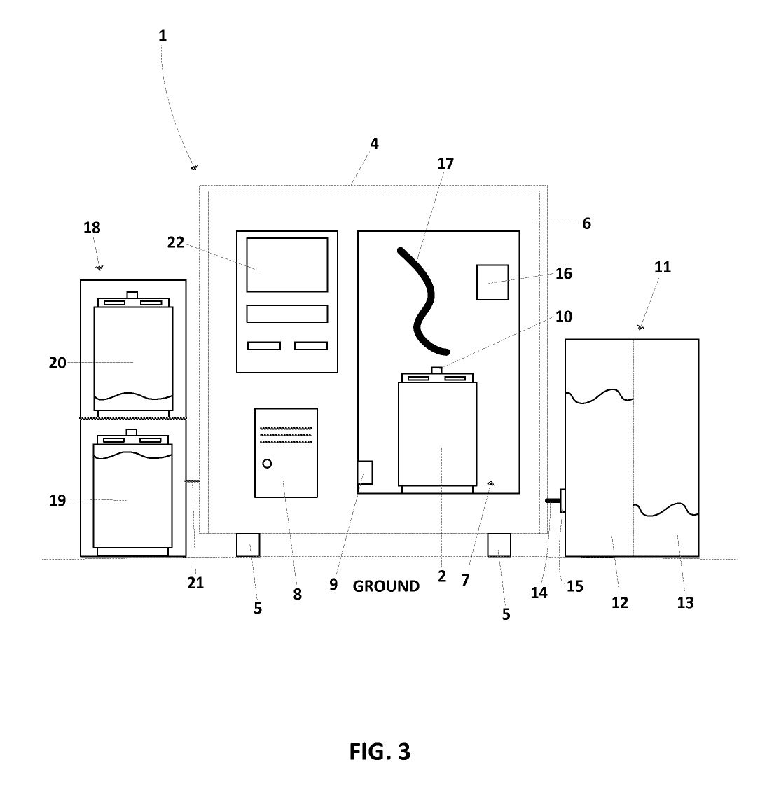

The housing 4 may include an aperture 7 on at least one of its outside surfaces as depicted in FIGS. 2-5. Typically, the aperture 7 may embody a tank filling compartment and may be configured to at least partially receive an individual fuel tank 2 on a front or side surface of the apparatus 1. For example, the aperture may be large enough to enable receipt of the fuel tank 2 so that the fuel tank 2 may be placed in or inserted at least partially within the housing 4 for processing (i.e., exchanging, purchasing, refilling, or returning). The aperture 7 may include an operatively openable, closable, detachable, or slidable door, window, or lid that ensures maximum safety during refilling or fuel dispensing operations. In some embodiments, the user may not be required to deposit the fuel tank 2 in the aperture 7 of the housing 4 for processing, but rather the user may exchange, purchase, refill, or return the fuel tank 2 at a location adjacent to the apparatus 1. In other embodiments, the aperture 7 may embody one or more access doors 8 for installation, configuration, or maintenance of the apparatus 1 as shown in FIGS. 3 and 5.

The present invention may include one or more sensors 9 positioned in, on, and around the apparatus 1 as illustrated in FIGS. 2-5. For example, one or more cameras, scales/weight sensors, optical sensors, metal detectors, motion detectors, temperature gauges, fuel content probes, or the like may be used while processing the fuel tank 2. In some embodiments, a weight sensor or scale 3 may be utilized in the aperture 7 to determine a weight associated with the fuel tank 2, a type of fuel currently in the fuel tank 2, or other information concerning the fuel tank 2. Based on this determination, the apparatus 1 may be configured to automatically dispense a matching fuel type, calculate how much fuel is required to substantially fill the fuel tank 2, or provide another service. In other embodiments, a meter or another type of sensor 9 may be used to detect a flow rate of fuel as it flows through the apparatus 1 to the fuel tank 2. This may assist the user in determining how much fuel is being input into the fuel tank 2 in order to avoid overfilling the fuel tank 2. In alternative embodiments, a sensor 9 may be used to determine if an inserted object is indeed a fuel tank 2, as well as a type of valve 10 associated with the fuel tank 2, by collecting, comparing, and analyzing the object's dimensional information. The type of valve 10 associated with the fuel tank 2 may be important as government regulations may not allow refilling of fuel tanks having certain types of valves. Image-matching or facial recognition technology may be utilized to identify the user as a new or returning customer, or for another purpose. The apparatus 1 may comprise one or more controllers (i.e., computing devices or processors) used to control the apparatus. Each of the sensors 9 may be controlled by, operated by, or communicates with a controller.

In some embodiments, the apparatus 1 may collect information associated with the fuel tank 2 before executing a tank exchange, purchase, refill, or return. In other embodiments, the apparatus 1 may collect information associated with the fuel tank 2 substantially simultaneously to or after executing a tank exchange, purchase, refill, or return. The apparatus 1 may retrieve information associated with the fuel tank 2 via at least one sensor 9, which may be located outside of, adjacent to, or inside the apparatus 1. Information associated with the fuel tank 2 may be retrieved when the fuel tank 2 is located outside of or adjacent to the apparatus 1, in the aperture 7, or, as noted above, when in an isolation or quarantined area or enclosure within the housing 4 of the apparatus 1. The retrieved information associated with the fuel tank 2 may be stored in a digital memory location for later recall or analysis. Based on the received information associated with the fuel tank 2, the apparatus 1 may be configured to determine the next appropriate step in executing or performing a desired service.

The apparatus 1 includes a storage tank 11 from which fuel is distributed into the fuel tank 2. Utilizing the storage tank 11 may eliminate the need for the entity to manage an inventory of multiple fuel tanks 2 stored in a corral, thus reducing costs associated with manual inventory checks and storing, refurbishing, exchanging, or replacing fuel tanks 2 The storage tank 11 may comprise one or more holding tanks which may be configured to distribute one or multiple types of fuel. For example, the storage tank 11 may include a liquid propane storage tank 12 and a natural gas storage tank 13, as depicted in FIGS. 3 and 4. In some embodiments, the storage tank 11 may be operatively coupled to or housed within the housing 4 of the apparatus 1 as shown in FIGS. 2 and 4. In other embodiments, the storage tank 11 may be positioned outside the housing 4 of the apparatus 1 (e.g., adjacent to the apparatus 1, offsite, or underground) as shown in FIGS. 3 and 5.

The apparatus 1 includes a fuel distribution mechanism 16 that operatively couples the storage tank 11 to the fuel tank 2. In one embodiment, the fuel distribution mechanism 16 comprises a fuel hose 14. A first end of the fuel hose 14 may be operatively coupled to a valve 15 associated with the storage tank 11 while the second end of the fuel hose 14 may be configured to extend outwardly from the apparatus 1 so that it may be coupled directly to the valve 10 associated with the fuel tank 2 as shown in FIGS. 2 and 5. The fuel distribution mechanism 16 controls the flow of fuel from the storage tank 11 to the fuel tank 2. In one embodiment, the fuel distribution mechanism 16 includes a pump or other mechanism operatively coupled to the fuel hose 14 for controlling the flow of fuel to the fuel tank 2. As seen in FIGS. 3 and 4, a second fuel hose 17 may be used to couple the fuel tank 2 to the pump or other flow control mechanism of the fuel distribution mechanism 16. The flow of fuel from the storage tank 11 through the fuel distribution mechanism 16 to the fuel tank 2 may be configured or controlled via the controller(s) of the apparatus 3 or another mechanism.

In some embodiments, the apparatus 1 may be configured to operatively couple the valve 10 of the fuel tank 2 to the fuel hose 14 or second fuel hose 17. In other embodiments, the apparatus 1 may prompt the user to manually couple the fuel hose 14 or the second fuel hose 17 to the valve 10 of the fuel tank 2. The fuel hose 14 or the second fuel hose 17 may be operatively coupled to the valve 10 of the fuel tank 2 via a screw-on device, a quick-release/lock device, or via another mechanical mechanism. Once the valve 10 of the fuel tank 2 is operatively coupled to the fuel hose 14 or the second fuel hose 17, the apparatus 1 may begin processing the fuel tank 2, wherein processing the fuel tank 2 includes dispensing fuel from the storage tank 11 through the fuel distribution mechanism 16 (e.g., the valve 15 associated with the storage tank 11, the fuel hose 14, the second fuel hose 17, the valve 10 associated with the fuel tank 2) ultimately into the fuel tank 2. Alternate paths for fuel to travel throughout the apparatus 1 may exist, and the fuel tank 2 may be operatively coupled to the apparatus 1 via other methods.

The apparatus 1 may be configured to test the integrity of the fuel tank 2 and/or the valve 10 associated with the fuel tank 2. Testing the integrity of the fuel tank 2 or its associated valve 10 may occur before, during, or after processing of the fuel tank 2 and may include collecting information associated with the fuel tank 2 via at least one sensor 9. In some embodiments, testing the integrity of the fuel tank 2 may include dispensing vapor (e.g., fuel vapor) from the storage tank 11 (or another location) and injecting vapor into the fuel tank 2 so that the apparatus 1 may determine if the fuel tank 2 and its associated valve 10 include a leak or are adequately compatible with standard filling operations. Injecting vapor into the fuel tank 2 is advantageous because if a leak in the fuel tank 2 or valve 10 is discovered, then the discovery will occur prior to filling of the fuel tank 2 with fuel. If the discovery were to occur after the filling of the fuel tank 2 with fuel, such fuel might have to be removed from the fuel tank 2 before returning the fuel tank 2 to the customer in order to prevent a fuel leak. Furthermore, testing the integrity of the fuel tank 2 and its valve 10 with vapor in lieu of fuel leaves the the fuel tank 2 and valve 10 in essentially the same condition as when the fuel tank 2 is received by the apparatus 1 (in other words, one would expect the empty tank to contain fuel vapor). For example, injecting vapor into the fuel tank 2 will not increase or decrease the amount of fuel in the fuel tank 2, whereas if fuel was injected into the fuel tank 2, the amount of fuel in the fuel tank 2 would change.

In some embodiments, the present invention may further include a fuel tank storage corral 18 as illustrated in FIGS. 3-5. Referring to FIGS. 3 and 4, the storage corral 18 may include space for storing at least one substantially full fuel tank 19 that is available for purchase and/or exchange as well as at least one substantially empty fuel tank 20 that has been returned after an exchange. In some embodiments, the storage corral 18 may be operatively coupled to or located inside the kiosk system 1. In other embodiments, the storage corral 18 may be located outside or adjacent to the apparatus 1. The present invention may also include a transport mechanism 21 for transporting the fuel tank 2 into the storage corral 18 or transport mechanism 21 for transporting a full fuel tank 19 or an empty fuel tank 20 from the storage corral 18 to the aperture 7 upon request, as depicted in FIGS. 3-5. The transport mechanism 21 for transporting tanks may include a conveyor belt, a pulley system, a robotic arm, or another device. In one embodiment, the transport mechanism 21 is operably connected to the controller(s) of the apparatus 3.

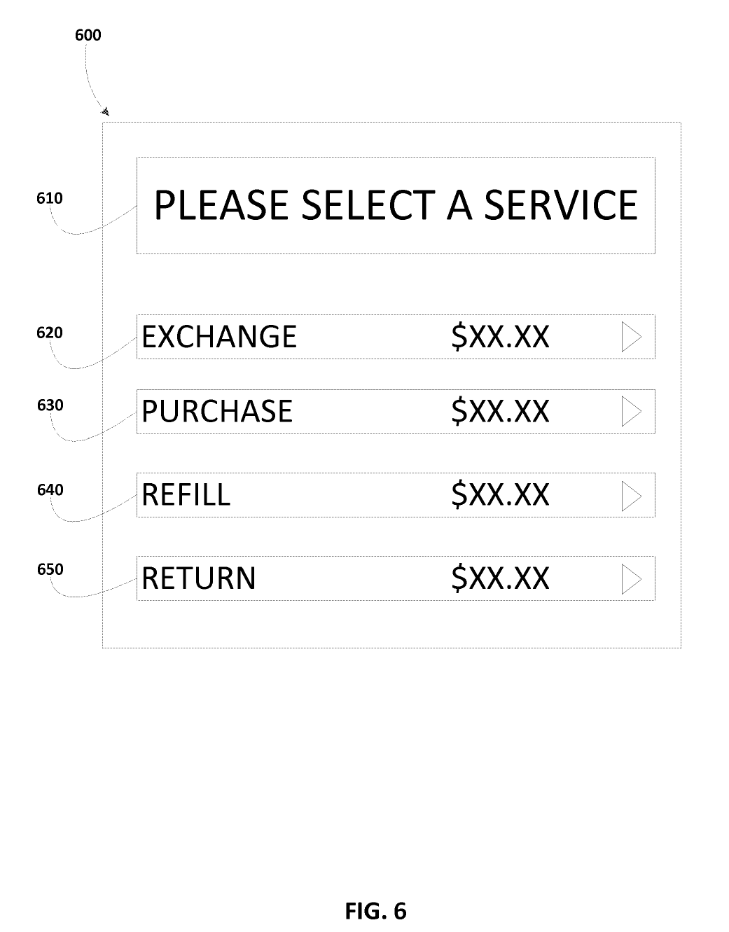

The apparatus 3 may include an interface in operable communication with the controller(s) to lead the user through an electronically-initiated process of exchanging, purchasing, refilling, or returning the fuel tank 2 as depicted in FIG. 6. The interface enables the user to select a desired service (e.g., the exchange, purchase, refill, or return of the fuel tank 2). The interface may be located substantially within or adjacent to the housing 4. The interface may comprise a display 22, such as touchscreen display or a display and keyboard, so that the user may easily interact with the apparatus 3. The interface may be configured to prompt the user for payment and the apparatus 3 may include a payment receiving mechanism (e.g., a cash receiving device or credit/debit card processor) in operable communication with the controller(s) for receiving payment for the exchange, purchase, refill, or return of the fuel tank 2. In one embodiment, the payment receiving mechanism may accept payment from the user in cash, a credit or debit card, a coin, a token, or via another method. In some embodiments, user authorization such as a pin code, a password, or the like may be required and such information may be entered via the interface. The apparatus 3 may be further configured to generate a receipt (e.g., using a printer) based on the user's transaction and may print the receipt on paper, or deliver the receipt via another method, such as via text or email. Once payment is received, the apparatus 3 will execute tank processing procedures.

If the user selects from the interface to exchange a substantially empty fuel tank 2 for a full fuel tank 19, the apparatus 3 may instruct the user via the interface to place the fuel tank 2 into the aperture 7 (or tank filling compartment) of the housing 4. In some embodiments, the apparatus 1 may be configured to retrieve the fuel tank 2 from the aperture 7 and move it to the storage corral 18 designated for empty fuel tanks 20. The apparatus 1 may then retrieve a full fuel tank 19 from the storage corral 18 and transport the full fuel tank 19 to the aperture 7 so that the user may retrieve the full fuel tank 19.

If the user selects from the interface to purchase a new full fuel tank 19, the apparatus 1 may retrieve a filled fuel tank 19 from the storage corral 18 and transport it into the aperture 7 of the housing 4 so that the user may retrieve the full fuel tank 19. Alternatively, the apparatus 1 may retrieve an empty fuel tank 19 from the storage corral 18 and transport it into the aperture 7 of the housing 4 where the empty fuel tank 19 is filled to a predetermined level so that the user may retrieve the full fuel tank 19.

If the user selects from the interface to refill a substantially empty fuel tank 2, the apparatus 3 may instruct the user via the interface to place the empty fuel tank 2 into the aperture 7 of the housing 4. Once the fuel tank 2 is received in the aperture 7, the apparatus 3 may collect information about the fuel tank 2 and its contents via the one or more sensors 9 located in, on, and around the housing 4. For example, the apparatus 3 may determine an amount of fuel remaining in the fuel tank 2, a type of fuel that is in the fuel tank 2, the shape of the empty fuel tank 2, the type of valve 10 associated with the fuel tank 2, or the like. The apparatus 3 may process or analyze the collected data so that a proper type and amount of fuel is dispensed from the storage tank 11 into the fuel tank 2 in a secure and efficient manner. The apparatus 3 may then control the flow of fuel from the storage tank 11 to the fuel tank 3 at a rate consistent with calculations conducted by the apparatus 3. In some embodiments, the user may be further instructed to manually connect one end of the fuel hose 14 that extends outwardly from the aperture 7 of the apparatus 1 to the valve 10 associated with the fuel tank 2. In other embodiments, the apparatus 1 may locate and identify the type of valve 10 associated with the fuel tank 2 and then mechanically connect the fuel hose 14 to the valve 10 associated with the fuel tank 2. In some embodiments, the apparatus 1 may be configured to retrieve the fuel tank 2 from the aperture 7 and position the fuel tank 2 at least partially inside the housing 4 before initiating the transfer of fuel from the storage tank 11 to the fuel tank 2. In other embodiments, the transfer of fuel between the storage tank 11 and the fuel tank 2 may occur with the fuel tank 2 outside of or adjacent to the housing 4.

If the user selects from the first interface to return an empty fuel tank 2, the apparatus 3 may prompt the user via the interface that instructs the user to place the fuel tank 2 into the aperture 7 of the housing 4. In some embodiments, the apparatus 1 may be configured to retrieve the fuel tank 2 from the aperture 7 and move it into the storage corral 18 designated for empty fuel tanks 20 using the transport mechanism 21.

The controller(s) may further enable the apparatus 1 to collect and track information associated with the level of fuel in the storage tank 11. In this regard, one or more sensors 9 in operable communication with a controller (i.e., a computing device or processor) may be configured to monitor and analyze information associated with the level of fuel in the storage tank 11. For example, a sensor 9 associated with the storage tank 11 may automatically monitor the level of remaining fuel in the storage tank 11. Based on a predetermined threshold of allowable remaining fuel, the apparatus 3 may communicate with the entity and transmit an acknowledgement or reminder to schedule a delivery appointment to refill the storage tank 11. In essence, the present invention may provide the entity with an automated system for collecting, analyzing, processing, and transmitting information (e.g., a tank inventory, fuel tank levels, a maintenance request, or the like) associated with the status of the apparatus 1 and its components. Therefore, the entity may be enabled to make more informed, timely, and cost-efficient business decisions associated with stocking, maintaining, and managing the apparatus 1 and its components and associated inventory of fuel and fuel tanks (e.g., empty tanks 20 available for filling). This information may be configured to be transmitted to and/or displayed via an remoter terminal, which may comprise a computing device, processor(s), and an interface (e.g., a display 22, a keyboard, a mouse, etc.).

Ultimately, the present invention enables the entity to provide a more efficient and cost effective service to its customers relative to exchanging, purchasing, refilling, or returning fuel tanks

In still other embodiments, the apparatus 1 may be configured to or include a scanner that is configured to scan and/or read a unique identifier (e.g., an RFID tag) associated with the fuel tank 2 to correctly identify information associated with the fuel tank 2, such as fuel levels, a requalification date, or the like. In such case, the apparatus 1 or scanner would be in operable communication with a controller. Additionally, the apparatus 1 may also be configured to detect leaks in the fuel tank 2 or other potential safety hazards associated with the fuel tank 2. The apparatus may further include or more safety device, including, but not limited to, a fire suppression device, a protective shielding, a device configured to monitor the levels of and/or remove gases such as oxygen, nitrogen, methane, carbon dioxide, and carbon monoxide, or any other potentially combustible or hazardous or noxious gases or the like. In such case, the at least one safety device may be in operable communication with a controller. In one embodiment, the apparatus 1 is configured to isolate or quarantine the fuel tank 2 (e.g., in a fortified enclosure and/or an enclosure having the one or more safety devices.

FIG. 1 illustrates a process flow 100 for a method of filling a fuel tank based on received sensory data or information. At block 110, the method comprises receiving a fuel tank. At block 120, the method comprises receiving data representing information associated with the fuel tank via at least one sensor. At block 130, the method comprises processing the data, wherein processing the data includes determining an amount of fuel required to fill the fuel tank to a predetermined level. At block 140, the method comprises dispensing the determined amount of fuel from a storage tank into the fuel tank.

FIGS. 2-5 illustrate various embodiments and perspective drawings of the fuel kiosk system.

FIG. 6 illustrates an exemplary user interface 600 for enabling a user to select a service associated with processing a fuel tank. The interface may present a prompt 610 to the user that instructs the user to select a service. The user may select a variety of services, including, but not limited to, exchanging a fuel tank 620, purchasing a fuel tank 630, refilling a fuel tank 640, and returning a fuel tank 650. Each service selection may include a price associated with performing the service. Upon the user's selection, a second interface may be presented to the user that prompts the user for payment, instructs the user how to continue processing of the fuel tank, or the like.

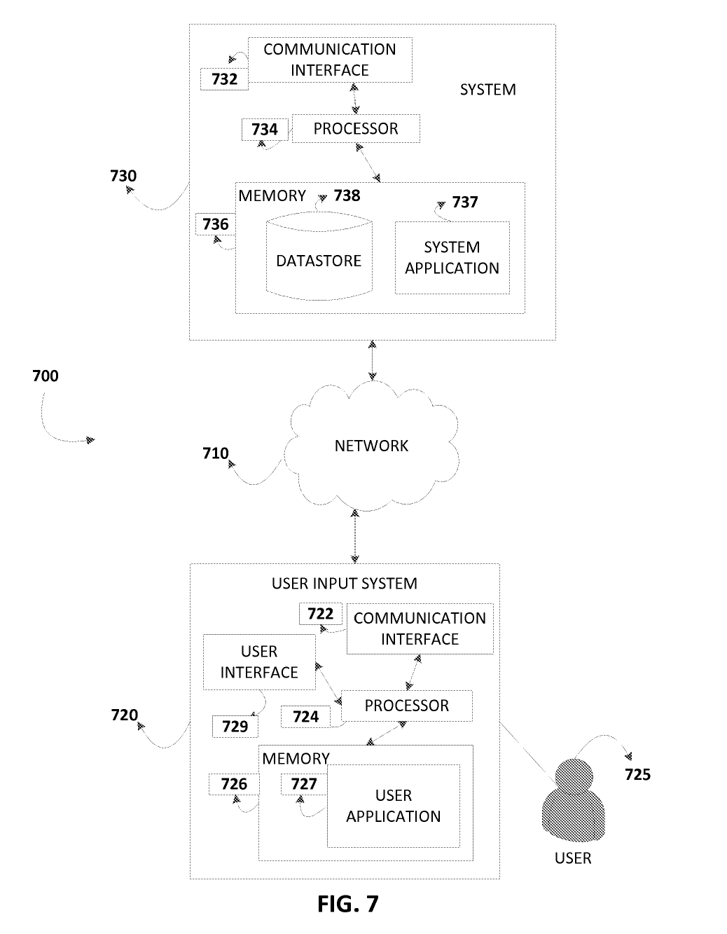

FIG. 7 presents an exemplary block diagram of the system environment 700 for implementing the process flow described in FIG. 1 in accordance with embodiments of the present invention. As illustrated, the system environment 700 includes a network 710, a user input system 720, and a system 730. Also shown in FIG. 7 is a user 725 of the user input system 720. The user input system 720 may be associated with the apparatus 1 as described herein. The user 725 may be a person who uses the user input system 720 to execute a user application 727. The user application 727 may be an application to communicate with the system 730, to enable the user 725 to select and initiate a service, input information onto a user interface presented on the user input system 720, or the like. The user application 727 and/or the system application 737 may incorporate one or more parts of any process flow described herein.

As shown in FIG. 7, the user input system 720 and the system 730 are each operatively and selectively connected to the network 710, which may include one or more separate networks. In addition, the network 710 may include a telecommunication network, local area network (LAN), a wide area network (WAN), and/or a global area network (GAN), such as the Internet. It will also be understood that the network 710 may be secure and/or unsecure and may also include wireless and/or wireline and/or optical interconnection technology.

The user input system 720 may include any computerized apparatus that can be configured to perform any one or more of the functions of the user input system 720 described and/or contemplated herein. For example, the user 725 may use the user input system 720 to transmit and/or receive information or commands to and from the system 730. In some embodiments, for example, the user input system 720 may include a personal computer system (e.g., a non-mobile or non-portable computing system, a motor vehicle, or the like), a mobile computing device, a personal digital assistant, a mobile phone, a tablet computing device, a network device, an interface associated with the apparatus 1, and/or the like. As illustrated in FIG. 7, in accordance with some embodiments of the present invention, the user input system 720 includes a communication interface 722, a processor 724, a memory 726 having an user application 727 stored therein, and a user interface 729. In such embodiments, the communication interface 722 is operatively and selectively connected to the processor 724, which is operatively and selectively connected to the user interface 729 and the memory 726. In some embodiments, the user 725 may use the user application 727 to execute processes described with respect to the process flows described herein. Specifically, the user application 727 executes the process flow described in FIG. 1.

Each communication interface described herein, including the communication interface 722, generally includes hardware, and, in some instances, software, that enables the user input system 720, to transport, send, receive, and/or otherwise communicate information to and/or from the communication interface of one or more other systems on the network 710. For example, the communication interface 722 of the user input system 720 may include a wireless transceiver, modem, server, electrical connection, and/or other electronic device that operatively connects the user input system 720 to another system such as the system 730. The wireless transceiver may include a radio circuit to enable wireless transmission and reception of information. Additionally, the user input system 720 may include a positioning system. The positioning system (e.g., a global positioning system (GPS), a network address (IP address) positioning system, a positioning system based on the nearest cell tower location, or the like) may enable at least one of the user input system 720 or an external server or computing device in communication with the user input system 720 to determine the location (e.g., location coordinates) of the user input system 720.

Each processor described herein, including the processor 724, generally includes circuitry for implementing the audio, visual, and/or logic functions of the user input system 720. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the user application 727 of the memory 726 of the user input system 720.

Each memory device described herein, including the memory 726 for storing the user application 727 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 7, the memory 726 includes the user application 727. The user application 727 may be associated with various features of the device identification program. In some embodiments, the user application 727 includes an interface for communicating with, navigating, controlling, configuring, and/or using the user input system 720. In some embodiments, the user application 727 includes computer-executable program code portions for instructing the processor 724 to perform one or more of the functions of the user application 727 described and/or contemplated herein. In some embodiments, the user application 727 may include and/or use one or more network and/or system communication protocols.

Also shown in FIG. 7 is the user interface 729. In some embodiments, the user interface 729 includes one or more output devices, such as a display and/or speaker, for presenting information to the user 725. In some embodiments, the user interface 729 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user 725. In some embodiments, the user interface 729 includes the input and display devices of a mobile device, which are operable to receive and display information.

FIG. 7 also illustrates a system 730, in accordance with an embodiment of the present invention. The system 730 may refer to the “apparatus” described herein. The system 730 may include any computerized apparatus that can be configured to perform any one or more of the functions of the system 730 described and/or contemplated herein. In accordance with some embodiments, for example, the system 730 may include a computer network, an engine, a platform, a server, a database system, a front end system, a back end system, a personal computer system, and/or the like. Therefore, the system 730 may be a server managed by the entity. The system 730 may be located at the facility associated with the entity or remotely from the facility associated with the entity. In some embodiments, such as the one illustrated in FIG. 7, the system 730 includes a communication interface 732, a processor 734, and a memory 736, which includes a system application 737 and a datastore 738 stored therein. As shown, the communication interface 732 is operatively and selectively connected to the processor 734, which is operatively and selectively connected to the memory 736.

It will be understood that the system application 737 may be configured to implement any one or more portions of the various user interfaces and/or process flow described herein. The system application 737 may interact with the user application 727. It will also be understood that, in some embodiments, the memory includes other applications. It will also be understood that, in some embodiments, the system application 737 is configured to communicate with the datastore 738, the user input system 720, or the like.

It will be further understood that, in some embodiments, the system application 737 includes computer-executable program code portions for instructing the processor 734 to perform any one or more of the functions of the system application 737 described and/or contemplated herein. In some embodiments, the system application 737 may include and/or use one or more network and/or system communication protocols.

In addition to the system application 737, the memory 736 also includes the datastore 738. As used herein, the datastore 738 may be one or more distinct and/or remote datastores. In some embodiments, the datastore 738 is not located within the system and is instead located remotely from the system. In some embodiments, the datastore 738 stores information or data described herein. For example, the datastore 738 may store information associated with the user's account.

It will be understood that the datastore 738 may include any one or more storage devices, including, but not limited to, datastores, databases, and/or any of the other storage devices typically associated with a computer system. It will also be understood that the datastore 738 may store information in any known way, such as, for example, by using one or more computer codes and/or languages, alphanumeric character strings, data sets, figures, tables, charts, links, documents, and/or the like. Further, in some embodiments, the datastore 738 may include information associated with one or more applications, such as, for example, the system application 737. It will also be understood that, in some embodiments, the datastore 738 provides a substantially real-time representation of the information stored therein, so that, for example, when the processor 734 accesses the datastore 738, the information stored therein is current or substantially current.

It will be understood that the embodiment of the system environment illustrated in FIG. 7 is exemplary and that other embodiments may vary. As another example, in some embodiments, the system 730 includes more, less, or different components. As another example, in some embodiments, some or all of the portions of the system environment 700 may be combined into a single portion. Likewise, in some embodiments, some or all of the portions of the system 730 may be separated into two or more distinct portions.

In addition, the various portions of the system environment 700 may be maintained for and/or by the same or separate parties. It will also be understood that the system 730 may include and/or implement any embodiment of the present invention described and/or contemplated herein. For example, in some embodiments, the system 730 is configured to implement any one or more of the embodiments of the process flows described and/or contemplated herein in connection any process flow described herein. Additionally, the system 730 or the user input system 720 is configured to initiate presentation of any of the user interfaces described herein.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more.”

What is claimed is:

1. A method for filling a fuel tank, the method comprising:
receiving a fuel tank;
receiving data associated with the fuel tank from at least one sensor;
processing the data, wherein processing the data comprises determining an amount of fuel required to fill the fuel tank to a predetermined level; and
dispensing the determined amount of fuel from a storage tank into the fuel tank.

2. The method according to claim 1, further comprising receiving the fuel tank at least partially in an aperture of a housing, wherein the aperture is configured to receive the fuel tank.

3. The method according to claim 1, further providing an interface that enables a user to select a service comprising at least one of exchanging, purchasing, refilling, and returning a fuel tank.

4. The method according to claim 1, wherein the data represents information comprising at least one of a weight of the fuel tank, a fuel type associated with the fuel tank, an amount of remaining fuel in the fuel tank, a type of valve in the fuel tank, and a location of the valve in the fuel tank.

5. The method according to claim 1, wherein the at least one sensor comprises a scale, a thermometer, a fuel gauge, a fuel probe, a camera, a motion detector, and a metal detector.

6. The method according to claim 1, wherein processing the data comprises determining a monetary value associated with the determined amount of fuel.

7. The method according to claim 6, further comprising prompting the user for payment of the determined monetary value.

8. The method according to claim 1, wherein the dispensing step comprises dispensing the fuel to the fuel tank through a hose.

9. The method according to claim 8, wherein a first end of the hose is operatively coupled to the storage tank while a second end of the hose is operatively coupled to the fuel tank.

10. The method according to claim 1, wherein the data represents information comprising the amount of fuel in the storage tank and further comprising:
transmitting the data to a remote terminal;
analyzing the data, via the remote terminal, to determine whether the amount of fuel in the storage tank has decreased below a predetermined level; and
when the amount of fuel in the storage tank has decreased below a predetermined level, filling the storage tank with fuel.

11. An apparatus for refilling a fuel tank with fuel, the apparatus comprising:
a storage tank configured to store fuel;
a controller;
at least one sensor, the at least one sensor being configured to assess data associated with the fuel tank, and wherein the at least one sensor is operatively connected to the controller and configured to transmit the data associated with the fuel tank to the controller;
a fuel distribution mechanism, the fuel distribution mechanism being operatively connected to the storage tank and controller and being configured to operatively connect to the fuel tank; and
wherein the controller processes the data to determine an amount of fuel required to fill the fuel tank to a predetermined level and wherein the controller activates the fuel distribution mechanism and the fuel distribution mechanism transfers fuel from the storage tank to the fuel tank until the fuel is filled to the predetermined level.

12. An apparatus according to claim 11, wherein the controller comprises:
a memory; and
a processor.

13. An apparatus according to claim 12, wherein the apparatus comprises a display in operable communication with the controller and wherein the controller further comprises:
a module stored in the memory, executable by the processor, and configured to present an interface on the display enabling a user to select a service associated with at least one of exchanging, purchasing, refilling, or returning the fuel tank.

14. An apparatus according to claim 12, wherein the controller further comprises a module stored in the memory, executable by the processor, and configured to:
receive the data associated with the fuel tank;
process the data associated with the fuel tank; and
activate the fuel distribution mechanism to initiate the dispensing of the determined amount of fuel from the storage tank into the fuel tank.

15. An apparatus according to claim 12, wherein the apparatus comprises a remote terminal and the controller further comprises a module stored in the memory, executable by the processor, and configured to:
receive data from the at least one sensor representing information comprising the amount of fuel remaining in the storage tank;
process the data; and
transmit data to the remote terminal.

16. An apparatus according to claim 11, further comprising a housing, the housing defines at least one aperture configured to at least partially receive the fuel tank.

17. The apparatus according to claim 16, wherein the house comprises an access door used to access the at least one aperture.

18. The apparatus according to claim 11, wherein the housing comprises a plurality of storage compartments for storing empty fuel tanks.

19. The apparatus of claim 11, wherein the apparatus further comprises at least one of a touchscreen display or a keyboard in operable communication with the controller.
